(19) United States
(12) Patent Application Publication
(10) Pub. No.: US 2026/0038071 A1
(43) Pub. Date: Feb. 5, 2026

(54) Universal Customer Identifiers

(71) Applicant: T-Mobile Innovations LLC, Overland Park, KS (US)

(72) Inventors: Jaideepsinh GOHIL, Overland Park, KS (US); Bobby WILLIAMS, Prairie Village, KS (US)

(21) Appl. No.: 18/789,631

(22) Filed: Jul. 30, 2024

(51) Int. Cl. G06Q 50/26; G06F 21/62; G06Q 50/50

(52) U.S. Cl. CPC G06Q 50/265; G06F 21/6245; G06Q 50/50

(57) ABSTRACT

A method of providing efficient universal user identifier (UUID) generation and resolution. The method includes receiving records associated with a user across different data sources, wherein each of the records comprises one or more personal identifiable information (PII) attributes; generating first signatures, each based on one or more PII attributes in a respective one of the records; searching for the first signatures in a database comprising UUIDs in association with customer signatures; determining, based on the searching, that one or more first signatures of the first signatures respectively match to one or more customer signatures of the customer signatures associated with a first UUID of the UUIDs; calculating a confidence score for the one or more matched customer signatures; determining that the user is a customer based on the confidence score satisfying a threshold; and configuring a telecommunications service configuration for the user based on the user being the customer.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Consumer information is widely available. For example, companies, organizations, billing systems, online services, marketing channels, and other entities may collect consumer information as part of service or product subscriptions, purchases, payments, etc. The collected consumer information may include demographic information, lifestyle information, purchasing habits, online activities, and/or other information pertaining to marketing efforts and/or marketing analytics.

### SUMMARY

In an embodiment, a method implemented in a network system to provide efficient Universal User Identifier (UUID) generation and resolution for identifying and tracking users based on UUIDs to facilitate telecommunications service configurations is disclosed. The method comprises receiving, by an UUID management application at a computing system, a plurality of records associated with a user across different data sources, wherein each of the plurality of records comprises one or more Personal Identifiable Information (PII) attributes of the user; generating, by the UUID management application, a plurality of first signatures, each based on one or more PII attributes in a respective one of the plurality of records; searching, by the UUID management application, for the plurality of first signatures in a customer database comprising a plurality of UUIDs in association with a plurality of customer signatures, wherein each of the plurality of UUIDs is associated with one or more respective ones of the plurality of customer signatures and identifies a specific customer; determining, by the UUID management application, based on the searching, that one or more first signatures of the plurality of first signatures respectively match to one or more customer signatures of the plurality of customer signatures associated with a first UUID of the plurality of UUIDs; calculating, by the UUID management application, a confidence score based on a sum of one or more reference weights, each indicative of a confidence level of one or more PII attributes used for generating a respective one of the one or more customer signatures; and determining, by the UUID management application, that the user is a current customer or a previous customer identified by the first UUID based on the confidence score satisfying a threshold; and configuring, by a telecommunications service application at the computing system, a first telecommunications service configuration for the user based on the user being the current customer or the previous customer.

In another embodiment, a method implemented in a network system to provide efficient universal user identifier (UUID) generation and resolution with user privacy consideration is disclosed. The method comprises receiving, by a UUID management application at a computing system, a plurality of records associated with a user across different application services, wherein each of the plurality of records comprises one or more personal identifiable information (PII) attributes of the user; filtering out, by the UUID management application, based on a privacy preference of the user, at least one record from the plurality of records to generate filtered records; generating, by the UUID management application, a plurality of first signatures based on the filtered records, wherein the generating comprises generating an individual one of the plurality of first signatures by applying a hash function to one or more PII attributes in a respective one of the filtered records; searching, by the UUID management application, for the plurality of first signatures in a customer database comprising a plurality of universal identifier (UUIDs), each in association with one or more respective ones of a plurality of customer signatures and identifying a respective one of a plurality of customers; determining, by the UUID management application, based on the searching, a match between one or more first signatures of the plurality of first signatures and one or more customer signatures of the plurality of customer signatures associated with a first UUID of the plurality of UUIDs; determining, by the UUID management application, a confidence score based on a sum of one or more reference weights, each indicative of a confidence level of a respective one of the one or more customer signatures being associated with a specific customer; and outputting, by the UUID management application, an indication that the first UUID is an identifier of the user based on the confidence score satisfying a threshold.

In yet another embodiment, a system is disclosed. The system comprises at least one processor; at least one non-transitory memory; a customer database comprising a plurality of universal identifiers (UUIDs), each in association with one or more respective ones of a plurality of customer signatures and corresponds to a different one of a plurality of customers; and a UUID management application comprising instructions stored at the at least one non-transitory memory, which when executed by the at least one processor, causes the UUID management application to receive a plurality of records, each comprising one or more personal identifiable information (PII) attributes associated with a user, wherein each of the plurality of records is associated with a different application service; generate a plurality of first signatures based on the plurality of records, wherein the generating comprises generating an individual one of the plurality of first signatures by applying a hash function to one or more PII attributes in a respective one of the plurality of records; determine that none of the plurality of UUIDs in the customer database correspond to the user based on a comparison of the plurality of first signatures of the user and the plurality of customer signatures in the customer database; generate a UUID for the user based on the determining that none of the plurality of UUIDs in the customer database correspond to the user; and add, to the customer database, the UUID for the user in association with the plurality of first signatures.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a network system according to an embodiment of the disclosure.

FIG. 2 is a block diagram illustrating example components and operations of a universal user identifier (UUID) management application according to an embodiment of the disclosure.

FIG. 3A illustrates an example master record according to an embodiment of the disclosure.

FIG. 3B illustrates an example record de-duplication operation according to an embodiment of the disclosure.

FIG. 3C illustrates an example attribute merge operation according to an embodiment of the disclosure.

FIG. 3D illustrates an example user privacy filtering operation according to an embodiment of the disclosure.

FIG. 4 illustrates an example reference weight table according to an embodiment of the disclosure.

FIG. 5 illustrates an example of a portion of a customer database according to an embodiment of the disclosure.

FIG. 6 is a flow chart of a method according to an embodiment of the disclosure.

FIG. 7 is a flow chart of another method according to an embodiment of the disclosure.

FIG. 8 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As described above, consumer information may be collected by various entities through service and/or product subscriptions, purchases, payments, etc. Some of the collected consumer information may be personal identifiable information (PII).

As used herein, the term “PII” may refer to any information that can be used to distinguish or trace an individual's identity, such as first name, last name, date of birth (DOB), and/or place of birth. The term “PII” may also include any other information that can be linked to an individual, for example, including, but not limited to, physical addresses, phone numbers, email addresses, zip codes, gender, health data, medical data, Billing Account Number (BAN), credit card number, and/or Mobile Station International Subscriber Directory Number (MSISDN). Further, the terms “PII” and “PII attributes” may be used interchangeably herein, such that a description referring to one of the terms shall be treated as though the description also referred to the other term.

In some scenarios, different entities may share information collected from the users, for example, to provide the users with more personalized, seamless, and targeted user experience. While PII can be used to identify an individual user and/or link to the individual user, some PII can change over time. For example, the first name, the last name, the physical address, the email address, the phone number, etc., of a user can change over time. Furthermore, a user may have multiple email addresses and/or phone numbers and may use different email addresses and/or different phone numbers to interact with different entities, different platforms, and/or different systems. As such, it may be unreliable to use PII directly for user identification.

The concept of a universal customer identifier has been introduced to uniquely refer to an individual customer, user, or entity that is intended to be used consistently across various systems, platforms, and databases. For example, a customer of an enterprise may be identified by the same universal customer identifier across different platforms, and also at different times (e.g., before cancellation of a service, after cancellation of a service, or even before purchasing a service). In one approach, a universal customer identifier is generated using the first three letters of different PII attributes of the customer directly to form the universal customer identifier. In some cases, the PII attributes may be part of private customer data. Thus, a universal customer identifier generated using such an approach can be vulnerable to security breaches and/or attacks. Other universal customer identifier generation and/or resolution approaches may involve a large amount of processing and/or manipulations of user data records that can be complex, inefficient, and costly.

The present disclosure provides a technical solution to the aforementioned technical problems in the technical field of user identification to provide more cost-effective and secure techniques for generating universal user identifiers (UUIDs) and resolving user identities across applications and data sources. According to an embodiment of the present disclosure, a UUID management application may be implemented on a computer system to provide UUID generations and/or customer identity resolution. The computer system may include processor(s) and non-transitory memory, where the UUID management application may include instructions stored at the non-transitory memory and executable by the processor(s).

For example, the UUID management application may receive records associated with a user across different (or disparate) data sources or application services. In an example, the computer system may belong to a certain enterprise or entity, and the different data sources providing the records may be associated with billing system(s) (e.g., an internal and/or external billing systems) and/or third-party vendor(s). Each of the records may include PII attributes of the user. As an example, one of the records may include a BAN, a MSISDN, a last name, and a DOB of the user, and another one of the records may include a last name, a phone number, and a DOB of the user. In general, the PII attributes may include, for example, but are not limited to, a first name, a last name, a gender, a DOB, a physical address, a zip code, an email address, a BAN, and/or a MSISDN of the user.

The UUID management application may generate user signatures (e.g., first signatures) for the user, where each individual user signature is based on PII attributes in a respective one of the records. That is, each individual user signature may represent the PII attributes in a respective record. For instance, if the UUID management application receives ten records related to a user, the UUID management application may generate ten individual user signatures, where each individual user signature is generated from the combination of PII attributes in a respective record. In other words, the UUID management application generates one user signature per received user record. To avoid embedding any portion of the PII attributes directly into the user signatures, the UUID management application may generate each of the user signatures by applying a deterministic function (e.g., a hash function) to the PII attributes in the respective record, where each user signature may include numerical values in any suitable format (e.g., decimal format, hexadecimal format, or binary format) and/or alphanumeric values. In a certain example, the hash function may be a Message Digest Method 5 (MD5) hash function.

In an embodiment, a customer database may be stored at the non-transitory memory. The customer database may store demographic data, product data, and/or behavioral data of customers of the entity. For demographic data, the customer database may store UUIDs of the customers in association with respective customer signatures of the customers. Each UUID may uniquely identify a specific customer and may be associated with (or mapped to) customer signatures of the specific customer. Each customer signature of the specific customer may be generated based on PII attribute(s) of the specific customer using the same deterministic function as for the user signatures. As an example, each entry in the customer database may store a UUID for a specific customer and a number of customer signatures generated from PII attributes of the specific customer. Generally, the customer database may store the UUIDs and associated customer signatures in any suitable way. Further, the customer database may store UUIDs and associated customer signatures for current customers and/or previous customers of the entity. That is, the customer database may continue to maintain and store UUIDs and associated customer signatures for customers that no longer utilize products and/or services of the entity. For product data, the customer database may store information related to products and/or services used (or subscribed to) by each customer, how the customer utilizes the products and/or services, and/or which products and/or services that the customer has opted out. In an example, the product data for a previous customer (who no longer utilizes products and/or services of the entity) may indicate that the previous customer has opted out of all products and/or services. The customer database may associate the product data for a specific customer to a UUID of the specific customer. For behavioral data, the customer database may store consumption histories of the customers and/or interactions with the customers. Similarly, the customer database may associate the behavioral data for a specific customer to a UUID of the specific customer.

After generating the user signatures for the user, the UUID management application may determine whether the user is one of the customers in the customer database based on the user signatures (generated from the incoming user's records). To that end, the UUID management application may search for the user signatures in the customer database. If none of the user signatures of the user match the customer signatures in the customer database, the UUID management application may determine that the user is not one of the customers in the customer database. That is, the user is a new customer of the entity. In an embodiment, based on the user being a new customer, the UUID management application may generate a UUID for the user (e.g., using a random number generator) and store the UUID of the user in association with the user signatures of the user in the customer database. If, however, a match is found between some of the user signatures and some of customer signatures, for example, associated with a first UUID of the UUIDs, in the customer database, the UUID management application may calculate a confidence score for the matched customer signatures. To that end, each of the customer signatures in the customer database may be associated with a reference weight indicative of a confidence level (e.g., a strength of accuracy) of the combination of PII attributes that were used to generate the respective customer signature. For example, a higher weight value may be assigned to PII attributes that are less likely to change for the specific customer and/or statistically more accurate in identifying and/or linking to the specific customer. That is, a higher weight value may indicate a higher confidence level. As an example, a customer signature that is generated based on a BAN, a MSISDN, a last name, and a DOB of a specific customer may be assigned with a higher weight value than a customer signature that is generated based on an email address and a gender of the specific customer. Thus, as part of determining the confidence score, the UUID management application may look up a reference weight for each of the matched customer signatures and calculate the confidence score by summing the reference weights for the matched customer signatures. The UUID management application may compare the confidence score to a threshold value to determine whether the matched signatures are sufficient in identifying the user. If the confidence score fails to satisfy the threshold value (e.g., less than the threshold value), the UUID management application may determine that the first UUID (associated with the matched customer signatures) does not correspond to the user. The failure to satisfy the threshold value may indicate that the user is a new user of the entity. In an embodiment, based on the user being a new customer, the UUID management application may generate a UUID for the user (e.g., using a random number generator) and store the UUID of the user in association with the user signatures of the user in the customer database. If, however, the confidence score satisfies the threshold value (e.g., equals to or greater than threshold value), the UUID management application may determine that the first UUID (associated with the matched customer signatures) corresponds to the user and that the user is a current customer or a previous customer of the entity.

In an embodiment, prior to generating the user signatures, the UUID management application may perform various processing to standardize the received records. For instance, the UUID management application may standardize the format of the PII attributes in the record, for example, based on a set of attribute format standardization rules. As an example, if a PII attribute is an email address, the UUID management application may remove sub-addressing from the email address. As another example, if a PII attribute is a phone number, the UUID management application may remove international digits, dashes, parentheses and/or spaces from the phone number. As a further example, if a PII attribute is a DOB, the UUID management application may arrange the DOB in a format of month-date-year. Additionally or alternatively, as part of the standardization, the UUID management application may delete duplicated record(s). For instance, the UUID management application may delete a first record of the records based on the first record being a duplicate of a second record of the records. That is, the first record and the second record may include the same PII attributes with the same values. Additionally or alternatively, as part of the standardization, the UUID management application may merge or resolve records with conflicting PII attribute values. That is, the UUID management may update a PII attribute value in one record using a PII attribute value in another record, for example, based on a set of merge rules. For instance, the UUID management application may detect that a first record of the records and a second record of the records include a common PII attribute with different values. To resolve the differences, the UUID management application may replace (or overwrite) a first value of the common PII attribute in the first record by a second value of the common PII attribute in the second record. In one example, the replacement of the first value (in the first record) by the second value (in the second record) may be based on the second record being updated more recently than the first record. In another example, the replacement of the first value by the second value may be based on the second record being updated within a certain time window. In a further example, the replacement of the first value by the second value may be based on the second record being received from a data source or application service that has a higher priority or a higher confidence level than the data source or application service from which the first record is received.

In an embodiment, the UUID management application may filter the records based on a privacy preference of the user prior to generating the user signatures. For instance, the UUID management application may filter out at least one of the records based on the privacy preference of the user, and the user signatures may be generated for the filtered records and not all the records. For instance, the privacy preference of the user may include opting out of sharing a specific PII attribute (e.g., the DOB or the gender) of the user or any PII attribute associated with a specific data source or application service (e.g., of a certain vendor).

In an embodiment, the entity may configure a telecommunications service for the user based on whether the user is a current customer, a previous customer, or a new customer. For instance, the computer system may further include a telecommunications service application stored at the non-transitory memory and executable by the processor(s). The UUID management application may provide the telecommunications service application with an indication of whether the user is a current customer, a previous customer, or a new customer. If the user is a current customer or a previous customer (i.e., a UUID of the user is found in the customer database), the telecommunications service application may configure the user with a first telecommunications service configuration (e.g., for a telecommunication service with a first set of service features and/or direct a first service or promotional offering to the user). If, however, the user is a new customer (i.e., a UUID was not initially found for the user in the customer database), the telecommunications service application may configure the user with a second, different telecommunications service configuration (e.g., for a telecommunication service with a second, different set of service features and/or direct a second, different service or promotional offering to the user). As an example, the first telecommunications service configuration for a current customer or a previous customer may include an indication of a certain version of a service or product with improvements or bug fixes that were made since the last version, whereas the second telecommunications service configuration for a new customer may include an indication of the service or product without the version, improvement, and/or bugfix information.

Using a function (e.g., a deterministic function) to generate signatures of a user from PII attributes of the user can be more secure than embedding portions of the PII attributes directly into a user's signatures. Weighting signatures based on the confidence level of the combinations of PII attributes used for generating the respective signatures as part of determining a confidence score for a match can increase the accuracy of identity resolution. Generating a UUID for a user using a random number generation and mapping the UUID to signatures of the user can provide an efficient way of generating a UUID for a user and/or resolving an identity of a user that can be used across different systems, platforms, services and/or different times. Furthermore, for the entity to have the ability to generate UUIDs and/or resolve identities of users instead of relying on a third-party UUID generation and/or resolution service, the entity can have the flexibility to provide updated identification information at any time (e.g., in real-time) rather than being limited to the update schedule of the third-party service (which may be sparse, e.g., once a day). Because of the efficiency and the flexibility, a standalone application programming interface (API) can be created to allow user identification (UUID generation and/or resolution) to be integrated as part of a workflow at the entity, for example, as data records are received by the computer system.

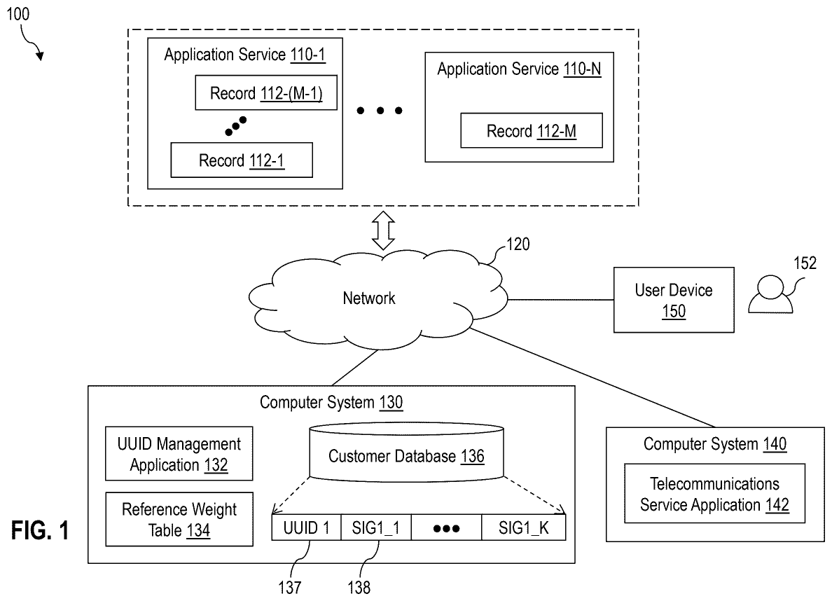

Turning now to FIG. 1, a network system 100 is described. The network system 100 includes N number of application services 110 (individually shown as 110-1 to 110N, where N may be any suitable integer value), a network 120, computing systems 130 and 140, and a user device 150 (e.g., of a user 152).

The network 120 promotes communication between the components of the network system 100. The network 120 may be any communication network including a public data network (PDN), a public switched telephone network (PSTN), a private network, and/or a combination. The user device 150 may be a cell phone, a mobile phone, a smart phone, a personal digital assistant (PDA), an Internet of Things (IoT) device, a wearable computer, a headset computer, a laptop computer, a tablet computer, a notebook computer, embedded wireless modules, and/or other wirelessly equipped communication devices (whether or not user operated).

The application services 110 may provide services to the user 152 via the user device 150, and the user 152 may interact (e.g., subscribe, purchase, payments, etc.) with the application services 110 via the user device 150. Generally, the application services 110 may provide services and interact with multiple users (e.g., 10 s, 100 s, 1000 s or more). The application services 110 may be related to, for example, but are not limited to, mobile phone services, billings, retails, metro services, healthcare services, credit card payment services, accounting services, entertainments, and/or marketing channels. In some examples, the application services 110 may be different from (or unrelated to) each other, e.g., have different business goals and for different service or business sectors. The application services 110 may also be provided or implemented on different platforms. In general, the application services 110 may be from disparate entities or systems.

The application services 110 may collect information from the user 152 through interactions with the user 152. Each of the application services 110 may store data about the user 152 in one or more records 112. In the illustrated example of FIG. 1, the application service 110-1 may store multiple records 112-1 to 112-(M−1) of the user 152, whereas the application service 110-N may store a single record 112-M about the user 152. In an embodiment, each of the records 112 may include one or more PII attributes of the user 152. Examples of PII attributes may include, but are not limited to, a first name, a last name, a gender, a DOB, a physical address, a zip code, a phone number, an email address, a BAN, or a MSISDN of the user 152. As an example, the record 112-1 may include the BAN, the MSISDN, the last name, and the DOB of the user 152, the record 112-(M−1) may include the email address, the DOB, and the gender of the user 152, and the record 112-M may include the last name, the phone number, and the DOB of the user 152. In general, different records 112 can include different PII attributes and/or the same PII attributes of the user 152.

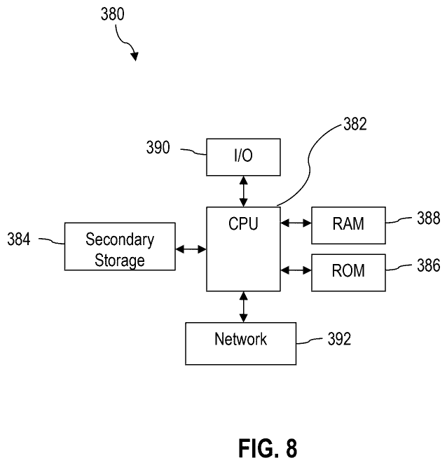

The computer system 130 may include a UUID management application 132 stored in non-transitory memory of the computer system 130 and executed by one or more processor(s) of the computer system 130. The computer system 130 may further include a reference weight table 134 and a customer database 136 stored in non-transitory memory of the computer system 130. The computer system 140 may include a telecommunications service application 142 stored in non-transitory memory of the computer system 140 and executed by one or more processor(s) of the computer system 140. In an embodiment, the computer systems 130 and 140 may be similar to the computer system 380 of FIG. 8. While FIG. 1 illustrates the telecommunications service application 142 implemented on the computer system 140 separate from the computer system 130, the telecommunications service application 142 can be implemented on the same computer system 130 as the UUID management application 132.

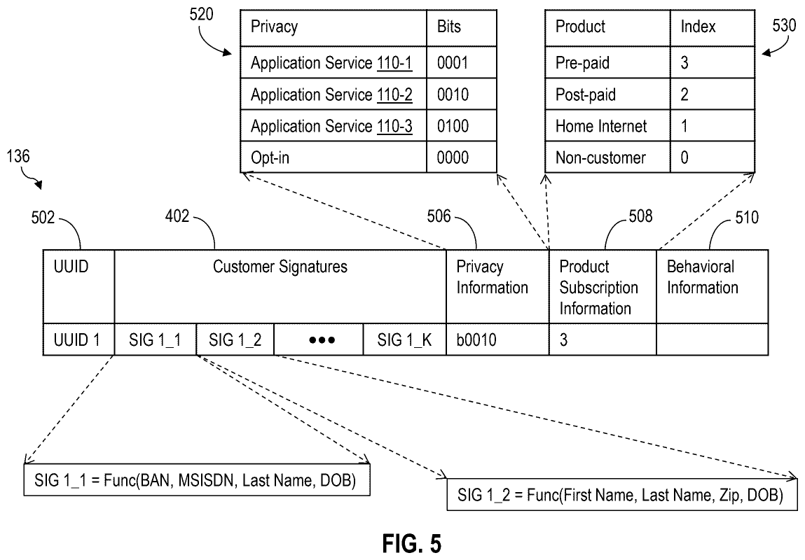

In an embodiment, the computer systems 130 and 140 may belong to a certain enterprise or entity. The customer database 136 may store demographic data, product data, and/or behavioral data of customers of the entity. For demographic data, the customer database 136 may store UUIDs 137 of customers in association with customer signatures 138 of the customers. For instance, each UUID 137 may uniquely identify a specific customer and is associated with (or mapped to) customer signatures 138 (e.g., SIG1_1, . . . , SIG1_K) of the specific customer. For ease of illustration, FIG. 1 only shows one customer entry (e.g., for a customer identified by UUID 1) in the customer database 136 and only one reference numeral 138 for the customer signature SIG1_1. Each customer signature 138 of the specific customer may be generated based on PII attribute(s) of the specific customer, for example, by applying a hash to the PII attribute(s). For product data, the customer database 136 may store information related to products and/or services used (or subscribed to) by each customer, how the customer utilizes the products and/or services, and/or which products and/or services that the customer has opted out. The customer database 136 may associate the product data for a specific customer to a UUID 137 of the specific customer. For behavioral data, the customer database 136 may store consumption histories of the customers and/or interactions with the customers. Similarly, the customer database 136 may associate the behavioral data for a specific customer to a UUID 137 of the specific customer. An example of a customer database 136 is provided in FIG. 5 and will be discussed more fully below.

In an embodiment, the customer database 136 may store UUIDs 137 and customer information (e.g., demographic data, product data, and/or behavioral data) for current customers and/or previous customers of the entity. That is, when a customer leaves the entity (e.g., cancels the service provided by the entity), the computer system 130 may continue to store and maintain the UUID 137 and corresponding customer information of that customer. As such, the UUID 137 not only uniquely identifies a specific customer or user across different services, systems, and/or platforms but also across different time (e.g., before cancellation of a service, after cancellation of a service, or even before purchasing a service).

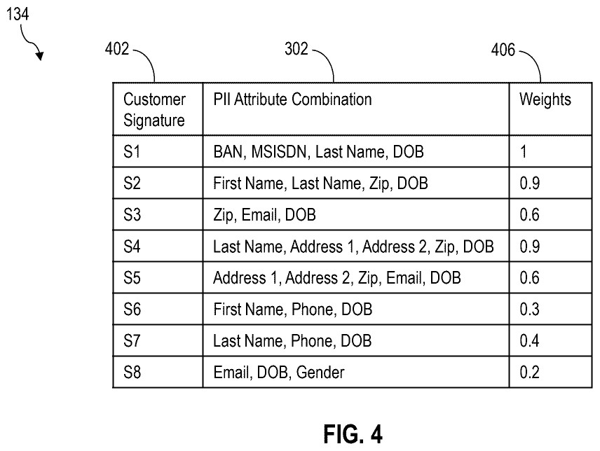

In an embodiment, each customer signature 138 may be associated with a reference weight indicative of a confidence level (e.g., a strength of accuracy) of the combination of PII attributes that were used to generate the respective customer signature 138. For example, a higher weight value may be assigned to PII attributes of an individual that are less likely to change over time and/or statistically more accurate in identifying and/or linking to the individual. The reference weight table 134 may store reference weights associated with the customer signatures 138 in the customer database 136. An example of a reference weight table 134 is provided in FIG. 4 and will be discussed more fully below.

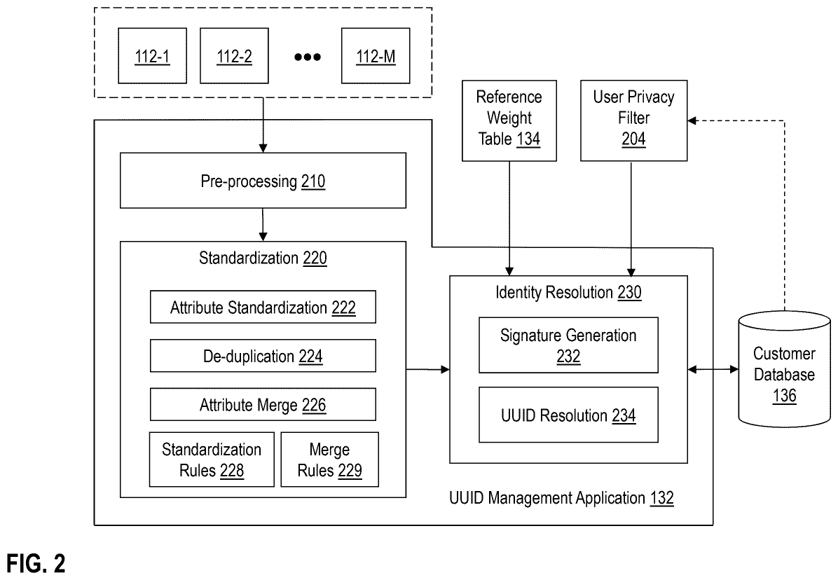

At a high level, the UUID management application 132 may generate new UUIDs 137 and signatures for new customers (e.g., using the same mechanisms as for generating the customer signatures 138 in the customer database 136) and add those new UUIDs 137 in association with corresponding customer signatures 138 to the customer database 136. When the UUID management application 132 receives a set of records 112 of a current customer or a previous customer, the UUID management application 132 may also perform identity resolution to respectively locate a UUID 137 of the current customer or the previous customer from the customer database 136. In embodiments, the UUID management application 132 may consider user privacy when performing UUID generation and/or identity resolution. In embodiments, the UUID management application 132 may communicate with the telecommunications service application 142 to enable the telecommunications service application 142 to provide users or customers with more personalized, seamless, and targeted user experience (e.g., target promotions). The operations of the UUID management application 132 and the telecommunications service application 142 will be discussed more fully below with reference to FIGS. 2, 3A-3D, and 4-7.

FIG. 1 is merely an example of components of a network system, and variations are contemplated to be within the scope of the present disclosure. In embodiments, the network system may include other components not illustrated in FIG. 1. In embodiments, the network system may not include every component illustrated in FIG. 1. In embodiments, the components and connections may be implemented with different connections than those illustrated in FIG. 1. Such and other embodiments are contemplated to be within the scope of the present disclosure.

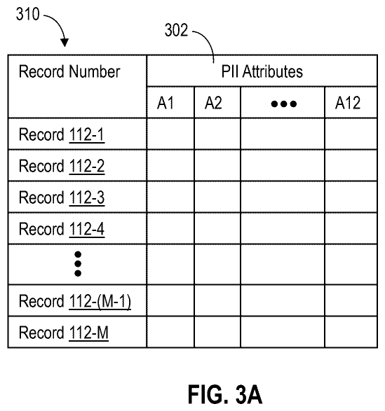

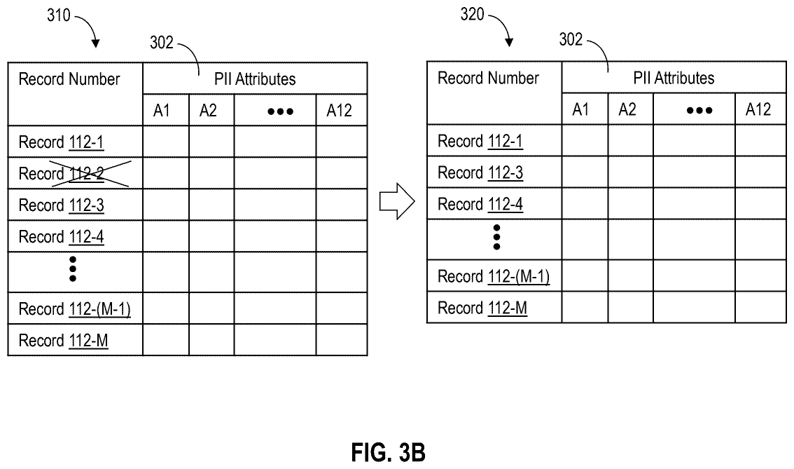

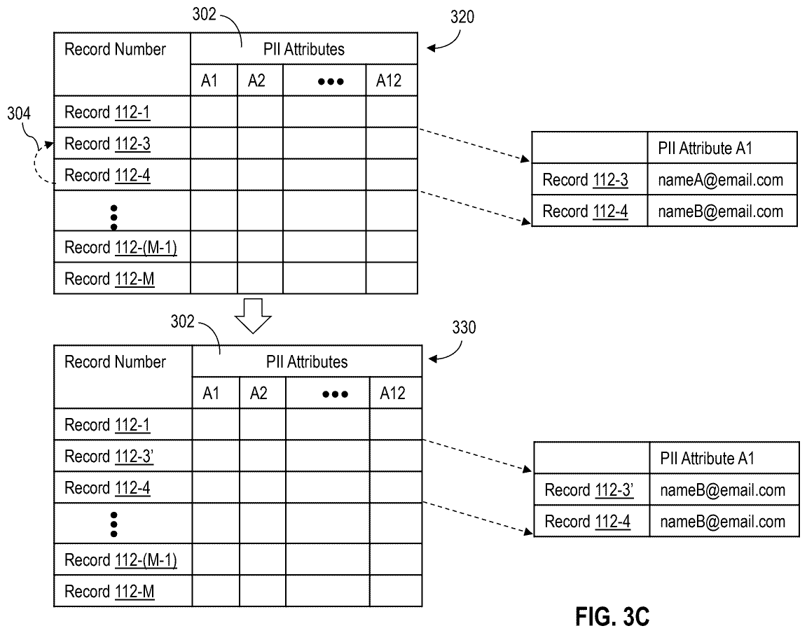

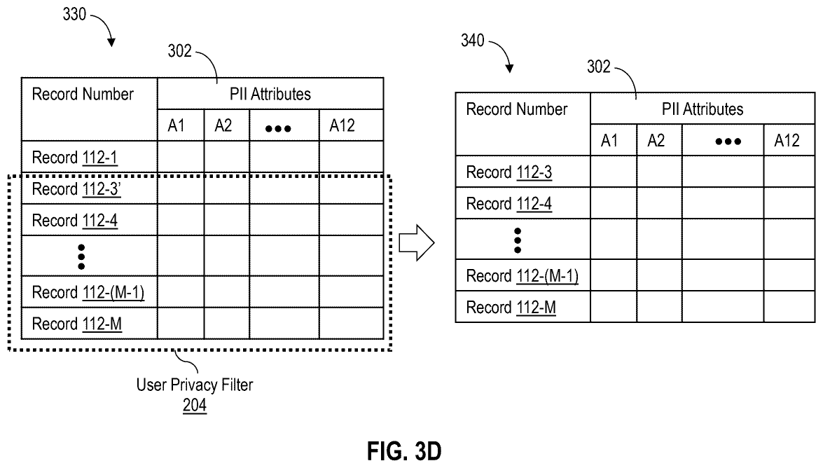

Turning now to FIG. 2, components and operations of the UUID management application 132 are described. The UUID management application 132 may perform various UUID related functions, for example, including a pre-processing function 210, a standardization function 220, and an identity resolution function 230. The pre-processing function 210 may receive a plurality of records 112 associated with the user 152 across different (or disparate) data sources or application services 110. Each of the plurality of records 112 may include one or more PII attributes (e.g., a first name, a last name, a gender, a DOB, a physical address, a zip code, an email address, a BAN, or a MSISDN) of the user 152. The pre-processing function 210 may generate a master record or table to store the plurality of records 112 (e.g., as shown FIG. 3A).

Turning now to FIG. 3A, an example master record 310 is described. The master record 310 includes all the received records 112 (e.g., individually shown as 112-1, 112-2, 112-3, 112-4, . . . , 112-(M−1), and 112-M). The records 112-1 to 112-M may include various combinations of PII attributes 302 of the user 152, for example, A1, A2, . . . , A12. For instance, A1 may be the email address of the user 152, A2 may be the first name of the user 152, and so on. In the illustrated example of FIG. 3A, each of the records 112 may be stored in a row of the master record 310, where PII attributes 302 of the record 112 may be stored in corresponding columns of the master record 310. In some examples, different records 112 may have different combinations of PII attributes 302 of the user 152. In some examples, at least two records 112 may include at least one common PII attribute 302 of the user 152. For instance, the record 112-1 may have PII attributes 302 A2 and A3, the record 112-2 may also have PII attributes 302 A2 and A3, the record 112-3 may have PII attributes 302 A1 to A5, the record 112-3 may have PII attributes 302 A1, A3, and A7, and so on. In general, the records 112 may be stored in the master record 310 in any suitable format.

Turning back to FIG. 2, the standardization function 220 may perform various processing to standardize the received records 112. For instance, the standardization function 220 may perform attribute standardization 222, record de-duplication 224, and attribute merge 226. For attribute standardization 222, the standardization function 220 may standardize the format (or syntax) of the PII attributes 302 in the records 112 based on a set of standardization rules 228. The standardization rules 228 may include one or more conditional operations. That is, a standardization rule 228 may specify that if a certain condition is satisfied, an operation is to be performed. For example, the standardization rules 228 may include a first standardization rule 228 to standardize the format of email addresses, a second standardization rule 228 to standardize the format of phone numbers, and a third standardization rule 228 to standardize the format of DOB.

The first standardization rule 228 may specify that sub-addressing in email addresses is to be removed. Stated differently, the first standardization rule 228 may specify that if a PII attribute 302 is an email address of a user with sub-addressing (e.g., a condition is satisfied), the sub-addressing is to be removed (e.g., a conditional operation). As an example, a PII attribute 302 in one of the records 112 (e.g., the record 112-1) may be an email address of the user 152 with sub-addressing, for example, stored as name+XYZ@email.com, where the sub-addressing begins with the symbol “+”. As such, as part of the attribute standardization 222, the standardization function 220 may remove the sub-addressing “+XYZ” from the email address so that the email address for the record 112-1 is stored as name@email.com in the master record 310.

The second standardization rule 228 may specify that international digits, dashes, parentheses, and/or spaces between the digits are to be removed. Stated differently, the second standardization rule 228 may specify that if a PII attribute 302 is a phone number of a user (e.g., a condition is satisfied), the international digits, dashes, parentheses, and/or spaces between the digits are to be removed (e.g., a conditional operation). As an example, a PII attribute 302 in one of the records 112 (e.g., the record 112-2) may be a phone number of the user 152, for example, stored as +1(234) 567-8999. As such, as part of the attribute standardization 222, the standardization function 220 may remove the international digits (e.g., “+1”), the dash, the parentheses, and the space between the digits of the phone number so that the phone number for the record 112-2 is stored as 2345678999 in the master record 310.

The third standardization rule 228 may specify that a DOB is to be stored in the format of “month-day-year”. Stated differently, the third standardization rule 228 may specify that if a PII attribute 302 is a DOB of a user (e.g., a condition is satisfied), the DOB is to be stored in the format of “month-day-year” (e.g., a conditional operation). As an example, a PII attribute 302 in one of the records 112 (e.g., the record 112-M) may be a DOB of the user 152, for example, stored as Jan. 1, 2000. As such, as part of the attribute standardization 222, the standardization function 220 may reformat the DOB according to the “month-day-year” format so that the DOB for the record 112-M is stored as 01-01-2000 in the master record 310. It should be appreciated that the standardization rules 228 may standardize the format for any types of PII attributes. As will be discussed more fully below, because signatures for the user 152 are generated by operating on (e.g., hashing) the PII attributes 302 of the user 152, the formats of the PII attributes 302 are to be standardized so that signatures generated from the same combination of PII attributes 302 may have the same signature value.

For record de-duplication 224, the standardization function 220 may delete duplicated records 112 (e.g., as shown in FIG. 3B). Turning now to FIG. 3B, an example record de-duplication 224 operation is described. For instance, the standardization function 220 may detect that the record 112-1 and the record 112-2 include the same PII attributes 302 with the same PII attribute 302 values. As such, the standardization function 220 may delete the record 112-2 based on the record 112-2 being a duplicate of the record 112-1 as shown by the symbol “X”. The master record 310 after the record de-duplication is shown by 320. In some examples, the records 112-1 and 112-2 may be received from the same application service 110. In other examples, the records 112-1 and 112-2 may be received from different application service 110.

Turning back to FIG. 2, for attribute merge 226, the standardization function 220 may merge or resolve records 112 with conflicting PII attribute 302 values based on a set of merge rules 229 (e.g., as shown in FIG. 3C). The merge rules 229 may include one or more conditional operations. That is, a merge rule 229 may specify that if a certain condition is satisfied, an operation is to be performed. For instance, the merge rules 229 may include a rule to resolve conflicting PII attribute 302 values based on when the PII attribute 302 values were last updated (e.g., by replacing an older PII attribute 302 value with a more recently updated PII attribute 302 value). Stated differently, a merge rule 229 may specify that if two records 112 have the same PII attribute 302 of a user but with different values (e.g., a condition is satisfied), the older PII attribute 302 value is to be replaced by the more recently updated PII attribute 302 value (e.g., a conditional operation).

Turning now to FIG. 3C, an example attribute merge 226 operation is described. For instance, the standardization function 220 may detect that the record 112-3 and the record 112-4 include a common PII attribute 302 with different values. In the illustrated example of FIG. 3C, the common PII attribute 302 is A1, where the record 112-3 includes “nameA@email.com” for A1 and the record 112-4 includes “nameB@email.com” for A1. To resolve the differences, the standardization function 220 may check the time at which the record 112-3 was last updated and the time at which the record 112-4 was last updated. As an example, the record 112-4 was updated in the last hour while the record 112-3 was updated 3 months ago. Thus, the standardization function 220 may replace the value of PII attribute 302 A1 in the record 112-3 by the value of the PII attribute 302 A1 in the record 112-4, where the merge is shown by the arrow 304. The master record 320 after the attribute merge 226 is shown by 330. The record 112-3 after the attribute merge 226 is shown by 112-3′. As shown in FIG. 3C, after the attribute merge 226, the record 112-3′ may include “nameB@email.com” for PII attribute 302 A1. In some examples, the records 112-3 and 112-4 may be received from the same application service 110. In other examples, the records 112-3 and 112-4 may be received from different application services 110. In some instances, the UUID management application 132 may also notify the application service 110 that provided the record 112-3 of the updated value “nameB@email.com” for the PII attribute 302 A1. In another example, the standardization function 220 may replace the value of PII attribute 302 A1 in the record 112-3 by the value of the PII attribute 302 A1 in the record 112-4 based on the record 112-4 being updated within a certain time window as specified by one of the merge rules 229. Stated differently, a merge rule 229 may specify that if two records 112 have the same PII attribute 302 of a user but with different values (e.g., a condition is satisfied), the PII attribute 302 value updated outside of the time window is to be replaced by the PII attribute 302 value updated within the time window (e.g., a conditional operation). In yet another example, the standardization function 220 may replace the value of PII attribute 302 A1 in the record 112-3 by the value of the PII attribute 302 A1 in the record 112-4 based on the record 112-4 being received from an application service 110 that has a higher priority or a higher confidence level than the application service 110 from which the record 112-3 is received. Stated differently, a merge rule 229 may specify that if two records 112 have the same PII attribute 302 of a user but with different values (e.g., a condition is satisfied), the PII attribute 302 value in the record 112 received from an application service 110 having a lower priority or lower confidence level is to be replaced by the PII attribute 302 value in the record 112 received from an application service 110 having a higher priority or a higher confidence level (e.g., a conditional operation).

Turning back to FIG. 2, after the standardization is performed, the identity resolution function 230 may perform signature generation 232 and UUID resolution 234. To protect user privacy, the identity resolution function 230 may filter the master record 330 prior to performing the signature generation 232, for example, by applying a user privacy filter 204 to the master record 330 as shown in FIG. 3D. For instance, the user 152 may configure a privacy preference to opt out of sharing a specific PII attribute 302 of the user 152 or any PII attribute 302 associated with a specific application service 110. The user privacy filter 204 may be based on the privacy preference of the user 152. In some examples, the UUID management application 132 may receive the privacy preference of the user 152 from an application service 110 along with respective record(s) 112. In some examples, the UUID management application 132 may retrieve the privacy preference of the user 152 from another system.

Turning now to FIG. 3D, an example user privacy filtering operation is described. For instance, the user 152 has opted out of sharing PII attribute 302 A12 of the user 152, and the record 112-1 includes the PII attribute 302 A12 of the user 152. Thus, the user privacy filter 204 may filter out the record 112-1. After the privacy filtering operation is performed, the filtered records are shown by 340 where the record 112-1 is excluded.

Turning back to FIG. 2, after applying the user privacy filter 204 to obtain the filtered records 340, the identity resolution function 230 may perform signature generation 232 to generate signatures for the user 152 based on the PII attributes 302 in the filtered records 340. During the signature generation 232, the identity resolution function 230 may generate a signature (e.g., a user signature) for each record 112 in the filtered records 340 by applying a function (e.g., a hash function) to the PII attributes 302 in the respective record 112. In a certain example, the hash function is a MD5 hash function. In general, the function can be any suitable deterministic function that can transform, encode, or map the PII attributes 302 to a value.

After generating the signatures for the user 152, the identity resolution function 230 may perform UUID resolution 234 to determine whether there is a UUID in the customer database 136 that identifies the user 152. As part of the UUID resolution 234, the identity resolution function 230 may search for the signatures of the user 152 in the customer database 136. For instance, for each UUID 137 in the customer database 136, the identity resolution function 230 may compare the signatures of the user 152 to the customer signatures 138 for that UUID 137. If none of the signatures of the user 152 matches the customer signatures 138 of all the UUIDs 137 in the customer database 136, the identity resolution function 230 may determine that the user 152 is a new customer of the entity. In an embodiment, based on the user 152 being a new customer, the identity resolution function 230 may generate a UUID 137 for the user 152 and store the UUID 137 of the user 152 in association with the user 152's signatures in the customer database 136. In an example, the UUID 137 for the user 152 may be generated based on a random number generation.

If, however, a match is found between at least some of the user 152's signatures and some of customer signatures 138, for example, associated with a first UUID 137 of the UUIDs 137, in the customer database 136, the identity resolution function 230 may calculate a confidence score for the matched customer signatures 138. To that end, each of the matched customer signatures 138 may be associated with a reference weight indicative of a confidence level (e.g., a strength of accuracy) of the combination of PII attributes 302 that were used to generate the respective customer signature 138. In an embodiment, the identity resolution function 230 may look up the reference weight table 134 (e.g., shown in FIG. 4) to retrieve reference weights for the matched customer signature 138.

Turning now to FIG. 4, an example reference weight table 134 is described. The reference weight table 134 includes a reference weight 406 for each customer signature 138 generated from a respective combination of PII attributes 302. A higher reference weight 406 value may be assigned to PII attributes 302 that are less likely to change for a specific customer and/or statistically more accurate in identifying and/or linking to the specific customer. In an example, the reference weight 406 may have values ranging from 0 to 1.0, where a higher value means a higher confidence for the respective combination of PII attributes 302 to be accurate in identifying the respective customer. In the illustrated example of FIG. 4, a customer signature 138 that is generated based on a BAN, a MSISDN, a last name, and a DOB of a specific customer may be assigned with a reference weight 406 value of 0.9 while a customer signature 138 that is generated based on an email address, a DOB, and a gender of the specific customer may be assigned with a reference weight 406 value of 0.2.

Turning back to FIG. 2, after looking up a reference weight 406 for each matched customer signature 138, the identity resolution function 230 may calculate the confidence score for the matched customer signatures 138 by summing the reference weights 406 for the matched customer signature 138. The identity resolution function 230 may compare the confidence score to a threshold value. If the confidence score fails to satisfy the threshold value (e.g., less than the threshold value), the identity resolution function 230 may determine that the user 152 is a non-customer or a new customer of the entity. In an embodiment, based on the user 152 being a new customer, the identity resolution function 230 may generate a UUID 137 for the user 152 (e.g., based on a random number generation) and store the UUID 137 of the user 152 in association with the user 152's signatures in the customer database 136. If, however, the confidence score satisfies the threshold value (e.g., equals to or greater than threshold value), the identity resolution function 230 may determine that the user 152 is a current customer or a previous customer of the entity and that the first UUID 137 is an identifier of the user 152. In an embodiment, the identity resolution function 230 may output an indication that the user 152 is a current customer or a previous customer, for example, in response to a request for a customer status of the user 152. In an embodiment, the identity resolution function 230 may output an indication of the first UUID 137, for example, in response to a request for a UUID 137 of the user 152.

Turning now to FIG. 5, an example of a portion of the customer database 136 is described. The customer database 136 may include a plurality of entries, each including a UUID 137 in association with one or more customer signatures 138, privacy information 506, product subscription information 508, and behavioral information 510. Each UUID 137 uniquely identifies a specific customer of the entity. The one or more customer signatures 138 associated with the UUID 137 are generated based on PII attributes 302 of the specific customer as discussed above. As shown in FIG. 5, the UUID 137 represented by UUID 1 are associated with customer signatures 138 shown by SIG 1_1, SIG 1_2, . . . , SIG 1_K, where K can be any suitable integer value. The signatures SIG 1_1, SIG 1_2, . . . , SIG 1_K are signatures of a specific customer (e.g., the user 152) and the UUID 1 identifies the specific customer. FIG. 5 further shows the calculation of the signatures SIG 1_1 and SIG 1_2. For instance, SIG 1_1 is computed by applying a function represented by Func (e.g., a hash) to PII attributes 302 of the specific customer including the BAN, the MSISDN, the last name, and the DOB of the specific customer, and SIG 1_2 is computed by applying the function Func to PII attributes 302 of the specific customer including the first name, the last name, the zip, and the DOB of the specific customer.

The privacy information 506 may indicate the privacy preference of a respective customer. An example privacy configuration 520 is shown in FIG. 5, where a customer may opt out of sharing or using PII attributes 302 collected from certain application service(s). For instance, a privacy setting of bits “0000” may indicate a customer opted in for sharing or using PII attributes 302 collected from all application services 110, a privacy setting of bits “0001” may indicate a customer opted out of sharing or using PII attributes 302 collected by the application service 110-1, a privacy setting of bits “0010” may indicate a customer opted out of sharing or using PII attributes 302 collected by the application service 110-2, and so on. In the illustrated example of FIG. 5, the privacy information 506 for the specific customer identified by UUID 1 is set to bit-values of 0010, indicating that the specific customer opted out of sharing or using PII attributes 302 from application service 112-2. In general, the privacy configuration 520 can include any PII attribute(s) 302 and/or application service(s) 110 that can be opted out by a user 152. Further, while FIG. 5 illustrates the privacy configuration 520 in the format of binary bits, where each bit corresponds to a certain application service 110 and may be set to a value of 1 to indicate opting out of the corresponding application service 110, the privacy configuration 520 may be in any suitable format.

The product subscription information 508 may indicate which products a respective customer is using. An example of product configuration 530 is shown in FIG. 5, where a pre-paid subscription is represented by 3, a post-paid subscription is represented by 2, a home Internet service is represented by 1, and a non-customer (e.g., with no product subscription) is represented by 0. In an example, a non-customer for the product subscription information 508 may indicate that a respective user is a previous customer of the entity and not currently subscribing to or utilizing any product or service of the entity. In the illustrated example of FIG. 5, the product subscription information 508 for the specific customer identified by UUID 1 is set to a value of 3, indicating that the specific customer has a pre-paid subscription. In general, the product configuration 530 can include any product and/or service subscriptions, and the product subscription information 508 may store information related to the product and/or services used (or subscribed to) by the respective customer, how the customer utilizes the products and/or services, and/or which products and/or services that the customer has opted out.

The behavioral information 510 may include consumption histories of a respective customer and/or interactions with the customer. For instance, the behavioral information 510 may include when the customer first subscribes to a certain product or service, how often and/or when the customer utilizes the certain product service, etc.

In an embodiment, the UUID management application 132 may receive a request, for example, from the telecommunications service application 142, about a certain user (e.g., the user 152) based on records 112 of the user. In response, the UUID management application 132 may provide information about the user, for example, an indication of a customer status (e.g., a current customer, a previous customer, or a new customer), product subscription information 508, and/or behavioral information 510 of the user. The product subscription information 508, and/or behavioral information 510 can enable the telecommunications service application 142 to select service features and/or direct service or promotional offerings that are relevant to the user.

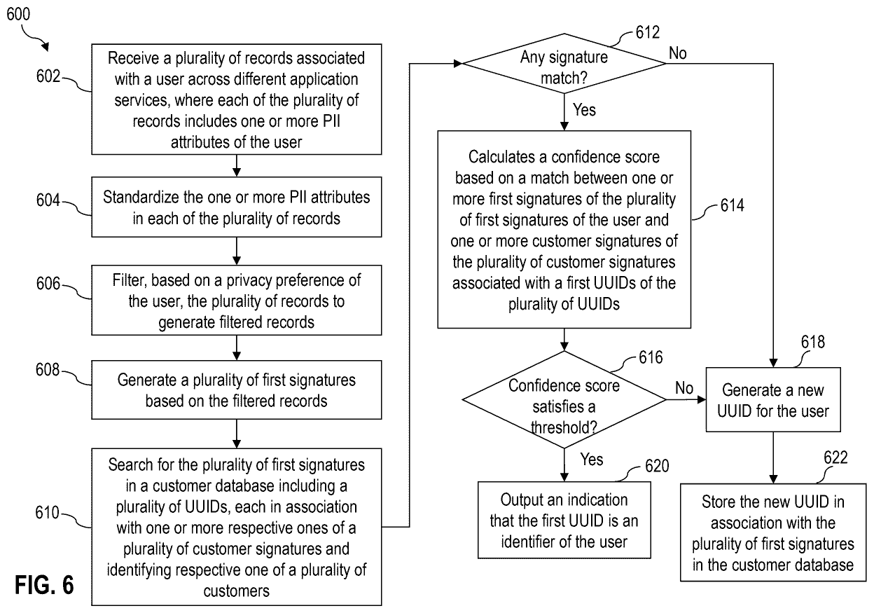

Turning now to FIG. 6, a method 600 is described. In an embodiment, the method 600 is a method of performing user identity resolution with user privacy consideration. The method 600 may include similar mechanisms as discussed above with reference to FIGS. 1-2, 3A-3D, and 4-5. In embodiments, the method 600 may be implemented using a computer system with components as shown in FIG. 8. As illustrated, FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At block 602, a UUID management application 132 receives a plurality of records 112 associated with a user 152 across different application services 110. Each of the plurality of records 112 includes one or more PII attributes 302 of the user 152. In an embodiment, the PII attributes 302 in the plurality of records 112 includes at least one of a first name, a last name, a gender, a DOB, a physical address, a zip code, an email address, a BAN, or a MSISDN of the user 152.

At block 604, the UUID management application 132 standardizes the one or more PII attributes 302 in each of the plurality of records 112. As part of standardizing the one or more PII attributes 302 in each of the plurality of records 112, the UUID management application 132 may modify, based on rules, one or more PII attributes 302 in an individual record 112 of the plurality of records 112, where the rules are associated with at least one of a standardized PII attribute format, a record de-duplication, or a PII attribute merge. For instance, the UUID management application 132 may standardize the formats of the PII attribute 302 values based on standardization rules 228, remove duplicated record(s) 112, and/or merge or update PII attribute 302 value(s) based on merge rules 229 as discussed above with reference to FIGS. 2 and 3A-3C.

At block 606, the UUID management application 132 filters out, based on a privacy preference (e.g., the user privacy filter 204) of the user 152, at least one record 112 from the plurality of records 112 to generate filtered records 340. In an embodiment, the privacy preference of the user 152 includes opting out of sharing a specific PII attribute 302 of the user 152 or any PII attribute 302 associated with a specific application service 110.

At block 608, the UUID management application 132 generates a plurality of first signatures (e.g., user signatures) based on the filtered records 340. As part of generating the plurality of first signatures, the UUID management application 132 generates each of the plurality of first signatures by applying a hash function to one or more PII attributes 302 in a respective one of the filtered records 340. In an embodiment, the hash function is a MD5 hash function.

At block 610, the UUID management application 132 searches for the plurality of first signatures in a customer database 136 including a plurality of UUIDs 137, each in association with one or more respective ones of a plurality of customer signatures 138 and identifying a respective one of a plurality of customers.

At block 612, the UUID management application 132 determines, based on the searching at block 610, whether there is a match between any of the plurality of first signatures of the user 152 and the customer signatures 138 in the customer database 136. If the UUID management application 132 determines that none of the plurality of first signatures of the user 152 matches the customer signatures 138 in the customer database 136, the UUID management application 132 proceeds to block 618.

At block 618, the UUID management application 132 generates a new UUID 137 for the user 152. At block 622, the UUID management application 132 stores the new UUID 137 in association with the plurality of signatures of the user 152 in the customer database 136.

Returning to block 612, if the UUID management application 132 determines that there is a match between one or more first signatures of the plurality of first signatures of the user 152 and one or more customer signatures 138 of the plurality of customer signatures 138 associated with a first UUID 137 of the plurality of UUIDs 137, the UUID management application 132 proceeds to block 614. At block 614, the UUID management application 132 calculates a confidence score based on the match between the one or more first signatures and the one or more customer signatures 138. To calculate the confidence score, the UUID management application 132 looks up a reference weight 406 for each matched customer signature 138 (e.g., from a reference weight table 134) and calculates a sum of the reference weight(s) for the one or more matched customer signatures 138.

At block 616, the UUID management application 132 determines whether the confidence sore satisfies a threshold. If the confidence score fails to satisfy the threshold, the UUID management application 132 performs the operations of blocks 618 and 622. If, however, the UUID management application 132 determines that the confidence score satisfies the threshold, the UUID management application 132 proceeds to block 620. At block 620, the UUID management application 132 outputs an indication that the first UUID 137 is an identifier of the user 152 based on the confidence score satisfying the threshold.

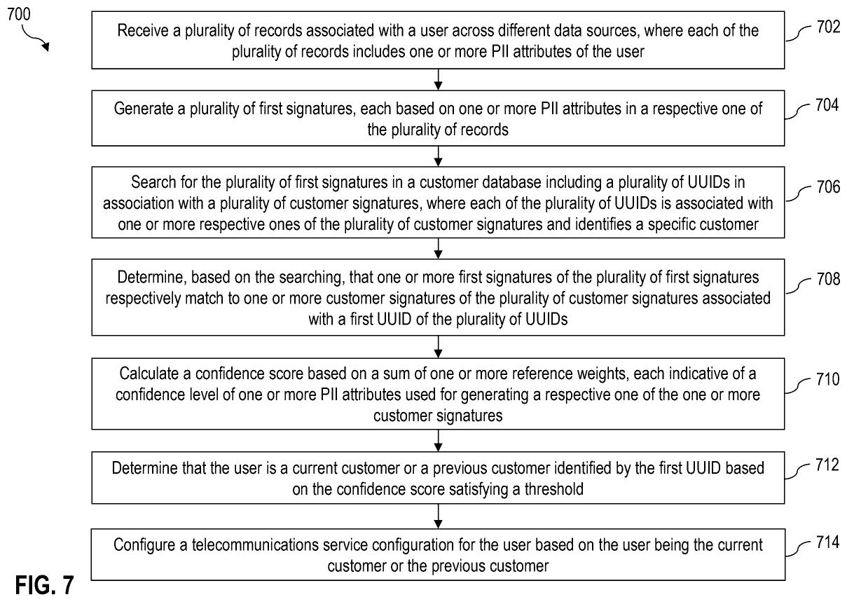

Turning now to FIG. 7, a method 700 is described. In an embodiment, the method 700 is a method of performing user identity resolution to facilitate telecommunications service configurations. The method 700 may include similar mechanisms as discussed above with reference to FIGS. 1-2, 3A-3D, and 4-6. In embodiments, the method 700 may be implemented using a computer system with components as shown in FIG. 8. As illustrated, FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At block 702, a UUID management application 132 receives a plurality of records 112 associated with a user 152 across different data sources (e.g., the application services 110). Each of the plurality of records 112 includes one or more PII attributes 302 of the user 152. In an embodiment, the different data sources providing the plurality of records 112 are associated with at least one of a billing system or a third-party vendor. In an embodiment, the PII attributes 302 in the plurality of records 112 includes at least one of a first name, a last name, a gender, a DOB, a physical address, a zip code, an email address, a BAN, or a MSISDN of the user 152.

At block 704, the UUID management application 132 generates a plurality of first signatures (e.g., user signatures), each based on one or more PII attributes 302 in a respective one of the plurality of records 112. In an embodiment, as part of generating the plurality of first signatures, the UUID management application 132 generates an individual signature of the plurality of first signatures by applying a hash function to one or more PII attributes 302 in a respective one of the plurality of records 112.

At block 706, the UUID management application 132 searches for the plurality of first signatures in a customer database 136 including a plurality of UUIDs 137 in association with a plurality of customer signatures 138, where each of the plurality of UUIDs 137 is associated with one or more respective ones of the plurality of customer signatures 138 and identifies a specific customer.

At block 708, the UUID management application 132 determines, based on the searching, that one or more first signatures of the plurality of first signatures respectively match to one or more customer signatures 138 of the plurality of customer signatures 138 associated with a first UUID 137 of the plurality of UUIDs 137.

At block 710, the UUID management application 132 calculates a confidence score based on a sum of one or more reference weights 406, each indicative of a confidence level of one or more PII attributes 302 used for generating a respective one of the one or more customer signatures 138.

At block 712, the UUID management application 132 determines that the user 152 is a current customer or a previous customer identified by the first UUID 137 based on the confidence score satisfying a threshold.

At block 714, a telecommunications service application 142 configures a telecommunications service configuration for the user 152 based on the user being the current customer or the previous customer. In some examples, the telecommunications service configuration may include a modification to a telecommunications service based on the user being the current customer or the previous customer. In some examples, the telecommunications service configuration may include an addition of a telecommunications service based on the user being the current customer or the previous customer.

In an embodiment, the UUID management application 132 further standardize, based on a PII attribute format rule (e.g., the standardization rule 228), a format of one or more PII attributes 302 in an individual record 112 of the plurality of records 112 prior to generating the plurality of first signatures at block 704. In an embodiment, the UUID management application 132 further deletes a first record 112 (e.g., the record 112-2) of the plurality of records 112 based on the first record 112 being a duplicate of a second record 112 (e.g., the record 112-1) of the plurality of records. In an embodiment, the UUID management application 132 further determines that a third record 112 (e.g., the record 112-3) of the plurality of records 112 and a fourth record 112 (e.g., the record 112-4) of the plurality of records 112 include a common PII attribute with different values and replaces, based on a PII attribute merge rules 229, a value of the common PII attribute in the third record 112 by a value of the common PII attribute in the fourth record 112.

In an embodiment, the UUID management application 132 further generates a plurality of second signatures based on a plurality of second records 112 associated with a second user 152 across different second data sources (e.g., application services 110). Each of the plurality of second signatures is generated based on one or more PII attributes 302 of the second user 152 in a respective one of the plurality of second records 112. The UUID management application 132 further determines that the second user 152 is a new customer based on a failure to match any of the plurality of second signatures to the plurality of customer signatures 138 in the customer database 136. The telecommunications service application 142 further configures a second telecommunications service configuration for the second user 152 based on the second user 152 being a new customer, wherein the second telecommunications service configuration is different than the telecommunications service configuration. For instance, the telecommunications service configuration is for a telecommunication service with a first set of features (e.g., a first rate plan), and the second telecommunications service configuration is for a telecommunications service with a second set of features different from the first set of features (e.g., a second, different rate plan).

In an embodiment, the UUID management application 132 generates a plurality of third signatures based on a plurality of third records 112 associated with a third user 152 across different third data sources (e.g., application services 110). Each of the plurality of third signatures is generated based on one or more PII attributes 302 of the third user 152 in a respective one of the plurality of third records 112. The UUID management application 132 further determines that one or more third signatures of the plurality of third signatures respectively match to one or more customer signatures 138 of the plurality of customer signatures 138 associated with a third UUID 137 of the plurality of UUIDs 137 in the customer database 136. The UUID management application 132 further calculates a third confidence score based on a sum of one or more reference weights 406, each indicative of a confidence level of one or more PII attributes 302 used for generating a respective one of the one or more customer signatures 138 matched to the one or more third signatures. The UUID management application 132 further determines that the third user is a new customer based on the third confidence score failing to satisfy the threshold. The telecommunications service application 142 further configures a third telecommunications service configuration for the third user based on the third user being a new customer, wherein the third telecommunications service configuration is different than the telecommunications service configuration.

In an embodiment, the customer database 136 further includes an association between the first UUID 137 and at least one of product subscription information 508 or behavioral information 510 of the user 152.

FIG. 8 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A method implemented in a network system to provide efficient universal user identifier (UUID) generation and resolution for identifying and tracking users based on UUIDs to facilitate telecommunications service configurations, wherein the method comprises:
receiving, by a UUID management application at a computing system, a plurality of records associated with a user across different data sources, wherein each of the plurality of records comprises one or more personal identifiable information (PII) attributes of the user;
generating, by the UUID management application, a plurality of first signatures, each based on one or more PII attributes in a respective one of the plurality of records;
searching, by the UUID management application, for the plurality of first signatures in a customer database comprising a plurality of UUIDs in association with a plurality of customer signatures, wherein each of the plurality of UUIDs is associated with one or more respective ones of the plurality of customer signatures and identifies a specific customer;
determining, by the UUID management application, based on the searching, that one or more first signatures of the plurality of first signatures respectively match to one or more customer signatures of the plurality of customer signatures associated with a first UUID of the plurality of UUIDs;
calculating, by the UUID management application, a confidence score based on a sum of one or more reference weights, each indicative of a confidence level of one or more PII attributes used for generating a respective one of the one or more customer signatures;
determining, by the UUID management application, that the user is a current customer or a previous customer identified by the first UUID based on the confidence score satisfying a threshold; and
configuring, by a telecommunications service application at the computing system, a first telecommunications service configuration for the user based on the user being the current customer or the previous customer.

2. The method of claim 1, further comprising:
standardizing, by the UUID management application, based on a PII attribute format rule, a format of one or more PII attributes in an individual record of the plurality of records prior to generating the plurality of first signatures.

3. The method of claim 1, further comprising:
deleting, by the UUID management application, a first record of the plurality of records based on the first record being a duplicate of a second record of the plurality of records.

4. The method of claim 1, further comprising:
determining, by the UUID management application, that a first record of the plurality of records and a second record of the plurality of records comprise a common PII attribute with different values; and
replacing, by the UUID management application, based on a PII attribute merge rule, a first value of the common PII attribute in the first record by a second value of the common PII attribute in the second record.

5. The method of claim 1, wherein the generating the plurality of first signatures comprises:
generating an individual signature of the plurality of first signatures by applying a hash function to one or more PII attributes in a respective one of the plurality of records.

6. The method of claim 1, wherein the PII attributes in the plurality of records comprises at least one of a first name, a last name, a gender, a date of birth (DOB), a physical address, a zip code, an email address, a billing account number (BAN), or a mobile station international subscriber directory number (MSISDN) of the user.

7. (canceled)

8. The method of claim 1, further comprising:
generating, by the UUID management application, a plurality of second signatures based on a plurality of second records associated with a second user across different second data sources, wherein each of the plurality of second signatures is generated based on one or more PII attributes of the second user in a respective one of the plurality of second records;
determining, by the UUID management application, that the second user is a new customer based on a failure to match any of the plurality of second signatures to the plurality of customer signatures in the customer database; and
configuring, by the telecommunications service application, a second telecommunication service configuration for the second user based on the second user being a new customer, wherein the second telecommunication service configuration is different than the telecommunications service configuration.

9. The method of claim 1, further comprising:
generating, by the UUID management application, a plurality of second signatures based on a plurality of second records associated with a second user across different second data sources, wherein each of the plurality of second signatures is generated based on one or more PII attributes of the second user in a respective one of the plurality of second records;
determining, by the UUID management application, that one or more second signatures of the plurality of second signatures respectively match to one or more customer signatures of the plurality of customer signatures associated with a second UUID of the plurality of UUIDs in the customer database;
determining, by the UUID management application, a second confidence score based on a sum of one or more reference weights, each indicative of a confidence level of one or more PII attributes used for generating a respective one of the one or more customer signatures matched to the one or more second signatures;
determining, by the UUID management application, that the second user is a new customer based on the second confidence score failing to satisfy the threshold; and
configuring, by the telecommunications service application, a second telecommunication service configuration for the second user based on the second user being a new customer, wherein the second telecommunications service configuration is different than the telecommunication service configuration.

10. The method of claim 1, wherein the customer database further comprises an association between the first UUID and at least one of product subscription information or behavioral information of the user.

11. A method implemented in a network to provide efficient universal user identifier (UUID) generation and resolution with user privacy consideration, wherein the method comprises:
receiving, by a UUID management application at a computing system, a plurality of records associated with a user across different application services, wherein each of the plurality of records comprises one or more personal identifiable information (PII) attributes of the user;
filtering out, by the UUID management application, based on a privacy preference of the user, at least one record from the plurality of records to generate filtered records;
generating, by the UUID management application, a plurality of first signatures based on the filtered records, wherein the generating comprises generating an individual one of the plurality of first signatures by applying a hash function to one or more PII attributes in a respective one of the filtered records;
searching, by the UUID management application, for the plurality of first signatures in a customer database comprising a plurality of universal identifier (UUIDs), each in association with one or more respective ones of a plurality of customer signatures and identifying a respective one of a plurality of customers;
determining, by the UUID management application, based on the searching, a match between one or more first signatures of the plurality of first signatures and one or more customer signatures of the plurality of customer signatures associated with a first UUID of the plurality of UUIDs;
determining, by the UUID management application, a confidence score based on a sum of one or more reference weights, each indicative of a confidence level of a respective one of the one or more customer signatures being associated with a specific customer; and
outputting, by the UUID management application, an indication that the first UUID is an identifier of the user based on the confidence score satisfying a threshold.

12. The method of claim 11, further comprising:
modifying, by the UUID management application, based on rules, one or more PII attributes in an individual record of the plurality of records, wherein the rules are associated with at least one of a standardized PII attribute format, a record de-duplication, or a PII attribute merge.

13. The method of claim 11, wherein the PII attributes in the plurality of records comprises at least one of a first name, a last name, a gender, a date of birth (DOB), a physical address, a zip code, an email address, a billing account number (BAN), or a mobile station international subscriber directory number (MSISDN) of the user.

14. The method of claim 11, wherein the privacy preference of the user comprises opting out of sharing a specific PII attribute of the user or any PII attribute associated with a specific application service.

15. The method of claim 11, further comprising:
generating, by the UUID management application, a plurality of second signatures based on a plurality of second records associated with a second user across different second application services, wherein each of the plurality of second signatures is generated based on one or more PII attributes of the second user in a respective one of the plurality of second records;
generating, by the UUID management application, a UUID for the second user based on a failure to match any of the plurality of second signatures to the plurality of customer signatures in the customer database; and
adding, by the UUID management application, to the customer database, the UUID of the second user in association with the plurality of second signatures.

16. The method of claim 11, further comprising:
generating, by the UUID management application, a plurality of second signatures based on a plurality of second records associated with a second user across different second data sources, wherein each of the plurality of second signatures is generated based on one or more PII attributes of the second user in a respective one of the plurality of second records;
determining, by the UUID management application, a match between one or more second signatures of the plurality of second signatures and one or more customer signatures of the plurality of customer signatures associated with a second UUID of the plurality of UUIDs;
determining, by the UUID management application, a second confidence score based on a sum of one or more second reference weights, each indicative of a confidence level of a respective one of the one or more customer signatures matched to the one or more second signatures;
generating, by the UUID management application, a UUID for the second user based on the second confidence score failing to satisfy the threshold; and
adding, by the UUID management application, to the customer database, the UUID of the second user in association with the plurality of second signatures.

17. A system comprising:
at least one processor;
at least one non-transitory memory;
a customer database comprising a plurality of universal identifiers (UUIDs), each in association with one or more respective ones of a plurality of customer signatures and corresponds to a different one of a plurality of customers; and
a UUID management application comprising instructions stored at the at least one non-transitory memory, which when executed by the at least one processor, causes the UUID management application to:
receive a plurality of records, each comprising one or more personal identifiable information (PII) attributes associated with a user, wherein each of the plurality of records is associated with a different application service;
generate a plurality of first signatures based on the plurality of records, wherein the generating comprises generating an individual one of the plurality of first signatures by applying a hash function to one or more PII attributes in a respective one of the plurality of records;
determine that none of the plurality of UUIDs in the customer database correspond to the user based on a comparison of the plurality of first signatures of the user and the plurality of customer signatures in the customer database;
generate a UUID for the user based on the determining that none of the plurality of UUIDs in the customer database correspond to the user; and
add, to the customer database, the UUID for the user in association with the plurality of first signatures.

18. The system of claim 17, wherein the hash function applied to the one or more PII attributes is a message digest method 5 (MD5) hash function.

19. The system of claim 17, wherein the UUID for the user is generated based on a random number generation.

20. The system of claim 17, wherein the instructions, when executed by the at least one processor, further causes the UUID management application to:
determine that none of the plurality of UUIDs in the customer database correspond to the user based on:
a failure to match any of the plurality of first signatures to the plurality of customer signatures in the customer database, or
a determination that a confidence score associated with one or more customer signatures of the plurality of customer signatures matched to one or more first signatures of the plurality of first signatures fails to satisfy a threshold, wherein the confidence score comprises a sum of one or more reference weights, each associated with a respective one of the one or more customer signatures.

21. The method of claim 1, wherein configuring the first telecommunications service configuration comprises programming a computing device to provide the user with a telecommunication service having a particular set of features determined according to the determination that the user is one of the current customer or the previous customer as identified by the first UUID and based on the confidence score satisfying the threshold.
